(19) United States
(12) Patent Application Publication
(10) Pub. No.: US 2013/0283857 A1
(43) Pub. Date: Oct. 31, 2013

(54) Fragrant ceramic ornament and accessory with surface sandblasted and carved and its producing method

(71) Applicant: Shanghai Top Harvest Design & Manufacture Co., Ltd., Shanghai (CN)

(72) Inventor: Huijing Chen, Shanghai (CN)

(21) Appl. No.: 13/515,288

(22) PCT Filed: Aug. 11, 2011
(86) PCT No.: PCT/CN11/01342

§ 371 Date: Jun. 12, 2012

(30) Foreign Application Priority Data
Jan. 11, 2011 (CN) 20111004504.7

(51) Int. Cl. A44C 15/00; B29C 71/02

(52) U.S. Cl. CPC A44C 15/002; B29C 71/02
USPC 63/1.15; 264/129; 501/153

(57) ABSTRACT

A fragrant ceramic ornament and accessory with surface sandblasted and carved, includes a body of ornament and accessory, formed by a ceramic body capable of diffusing fragrance, wherein the ceramic body has a surface as an glaze layer or an electroplated layer which has concave pattern by sandblasting carving, wherein the concave pattern is an exposed portion of the ceramic body which loses the glaze layer or the electroplated layer and is concave on the surface of the ceramic body, wherein essential oil is absorbed into an inside of the ceramic body via the exposed portion. The surface carving is by a sandblasting process, which has long fragrance diffusing time and ability to change fragrance according to circumstances, so as to achieve an object of repeatedly using which is economical and environment-friendly, and prevent the perfume from contacting with the skin or clothes directly. The present invention combines the ornament and accessory with fragrance well, and provides that a user has carryon fragrance as wearing the ceramic ornament and accessory according to the present invention, so as to avoid spraying perfume on a body thereof.

### CROSS REFERENCE OF RELATED APPLICATION

This is a U.S. National Stage under 35 USC 371 of the International Application PCT/CN2011/001342, filed Aug. 11, 2011.

### BACKGROUND OF THE PRESENT INVENTION

1. Field of Invention

The present invention relates to an ornament and accessory, and more particularly to a fragrant ceramic ornament and accessory with surface sandblasted and carved and its producing method.

2. Description of Related Arts

With the development diversification of fashion culture, people have wider choices for ornaments and accessories of different materials, and have higher requirements in selecting the styles. Wearing the ornaments and accessories does not only meet the requirement of decorating, but also meet the requirement of showing the symbols of one's own glamour and connotation, and spiritual aspirations. It is required that the ornaments and accessories have more changes and improvements on materials, designs, colors, and functions. Especially, the development of modern technology and improvement of life level increase the requirement about various products capable of diffusing fragrance. If the ornaments and accessories can diffuse different fragrance according to personal preference and different circumstances, the personality of the ornaments and accessories are enhanced, and the charm and personality of oneself is formed, so that people and the ornaments and accessories complement to each other.

The traditional jewels, such as rings, necklaces, pendants and earrings, are ordinarily made of precious metals and embedded with gems. They are welcome by people for good decoration and symbolic meaning, but are simple in function and usability, and even unable to diffuse fragrance.

However, the traditional perfume-like fragrant products do not have decorative effect to body. Although they have enhanced effect of diffusing fragrance due to volatility of alcohol, the fragrance lasts for short, and people need to use them everyday. Besides, the perfumes have plenty of volatilizing components, which will hurt people's skin or bring discomfort, and those accessories using essential oil will stain or even discolor clothes, deform leather and plastic, and causes discomfort or even anaphylaxis due to the biochemical property of the essential oil.

Accordingly, it is a problem for developing ornaments and accessories to improve fragrant the styles and materials of traditional ornaments and accessories, provide more novelty and personality, and combine the use and fragrance to diffuse for long, change different fragrances conveniently, avoid negative affect to body and clothes.

A Chinese patent application having publish number of CN201333888Y, and name of ceramic accessory capable of diffusing fragrance, discloses a ceramic plate which is adsorbed with essence therein by dropping, spraying or dipping. The ceramic accessory is placed in rooms, vehicles, chests, drawers and lavatories, or suspended on bedside or doors, so as to eliminate smells and clear the air. In the above reference, although the ceramic is utilized for adsorbing and diffusing fragrance, it can not avoid contacting with body and clothes as an accessory close to human, and thus will stain or even discolor clothes, deform leather and plastic, and causes discomfort or even anaphylaxis if directly contacting with human skin. However, the above prior art can not avoid or solve the problem, and thus is not reliable in using and limits the application within the scope that does not contact with body or clothes directly.

A Chinese patent application having publish number of CN201414497Y, and name of perfume pendant, discloses a pendant body used on a necklace, a perfume vial is positioned inside the pendant body, and has a pressing nozzle extending from the pendant body. An arc buckle is further provided on the pendant body, and has a first end which is extendable and mounted on the pendant body, and a second end having a surface provided above the pressing nozzle of the perfume vial. When using, by pressing the arc buckle, the end above the pressing nozzle of the perfume vial presses the pressing nozzle of the perfume vial to spray perfume for supply fragrance. In the above prior art, the pendant is combined with fragrance, but its structure is complicated, the operation is inconvenient, and can not avoid the common problems of the perfume products mentioned above by supplying fragrance by perfume.

A Chinese patent application having publish number of CN101518386A, and name of ornament capable of continuously diffusing fragrance, coating of picture layer, and coating method thereof is cited herein. The ornament is made by coating 1-3 layers of coating layers containing spice onto materials of synthetic resin, metal, glass or wood. The prior art combines ornament and fragrance, and the surface coating layer can continuously diffuse fragrance. However, once the coating layer capable of diffusing fragrance which has certain style is coated onto the ornament, the user can not change to other fragrance style freely, but has to keep using the existing fragrance. To change the fragrance style, the ornament must also be changed, which is forcing and limiting in using. When the fragrance of the coating layer of the ornament diffuses up, it can not be added new fragrance, and thus causes great waste. The ornament can not separate the coating layer containing spice from the skin or clothes, and bring discomfort to the user when sweating or other circumstances.

A Chinese patent application having publish number of CN2196396Y, and name of replaceable perfume ornament is cited herein. It is formed by a ceramic plate capable of absorbing perfume and an openable shell. The shell comprises two shell bodies having hollow air holes, and a connector to form an entirety capable of opening and closing freely, wherein the ceramic plate is positioned inside the shell bodies. Although the ornament can avoid the discomfort and hurt brought by that the perfume contacts with body directly, the manner that the shell bodies is used as housing will increase the volume and weight of the product to limit its application, and the operation of opening, removing, and closing is also inconvenient when changing perfume, so as to complicate the use of the product.

### SUMMARY OF THE PRESENT INVENTION

An object of the present invention is to solve the above drawbacks, and provide a fragrant ceramic ornament and accessory with surface sandblasted and carved and its producing method. Surface carving is by a sandblasting process, which has new design, special materials, long fragrance diffusing time and ability to change fragrance according to circumstances, so as to achieve an object of repeatedly using which is economical and environment-friendly, and prevent the perfume from contacting with the skin or clothes directly. The present invention combines the ornament and accessory with fragrance well, and provides that a user has carryon fragrance as wearing the ceramic ornament and accessory according to the present invention, so as to avoid spraying perfume on a body thereof. The fragrant ceramic ornament and accessory according to the present invention adds function and enjoyment of the ornament and accessory besides artistic and fashional appearance, which is scientific, safe and convenient.

The present invention is realized by the following technical proposal.

A fragrant ceramic ornament and accessory with surface sandblasted and carved according to the present invention, comprises:

a body of ornament and accessory, formed by a ceramic body capable of diffusing fragrance, wherein the ceramic body has a surface as an glaze layer or an electroplated layer which has concave pattern by sandblasting carving, wherein the concave pattern is an exposed portion of the ceramic body which loses the glaze layer or the electroplated layer and is concave on the surface of the ceramic body, wherein essential oil is absorbed into an inside of the ceramic body via the exposed portion.

Preferably, the ceramic body absorbs the essential oil into the inside of the ceramic body via the concave pattern by dropping, spraying or dipping.

Preferably, the ceramic body is a decorating part of different colors, shapes and sizes, and various pattern is formed on the surface of the ceramic body via sandblasting carving according to designing requirements, and meanwhile, the ceramic body is hollow.

Preferably, for convenience of wearing the ornament and accessory, the ceramic body has a through hole thereon, for connecting with metal, leather, or strand to form an ornament and accessory entirety.

Preferably, the glaze layer on the surface of the ceramic body is a thin film of glass material, has good isolation effect of separating gas and liquid.

A producing method of the fragrant ceramic ornament and accessory with surface sandblasted and carved according to the present invention, comprises:

first step of, producing a ceramic model with pug;

second step of, drying the ceramic model;

third step of, glazing the dried ceramic model;

fourth step of, burning the glazed ceramic model in a furnace to sinter the glaze with the pug; and

fifth step of, carving various concave pattern on the surface of the ceramic via sandblasting carving.

Preferably, after the fourth step, the sintered product is electroplated before the fifth step. The electroplating step is limited to products needing metallic texture and effect but ordinary products.

Preferably, in the fourth step of sintering, a temperature thereof is 1200±10° C., and a time thereof is 12˜15 hours.

The present invention further provides a pug for producing the fragrant ceramic ornament and accessory with surface sandblasted and carved, comprises SiO₂ of 36.8%, Al₂O₃ of 60.20%, K₂O of 0.8%, and Na₂O of 2.2% by weight.

In the present invention, after the surface of the ceramic body is carved by sandblasting with a sandblasting carving machine, the glaze layer or the electroplated layer on the surface of the ceramic body corresponding to a designed pattern is removed, so as to form the concave pattern of certain depth on the surface of the ceramic body. The concave pattern can be designed into various artistic effects according to different effect. The depth of the sandblasting carving is determined by a spraying pressure and spraying time of a spraying gun.

In the present invention, the exposed portion of the ceramic body of the ornament and accessory losing the glaze layer or the electroplated layer due to sandblasting carving, can absorb the essential oil into the inside of the ceramic body by dropping, spraying or dipping. Thus, fragrance can diffuse continuously for long from the surface of the ceramic body via the exposed portion of the ceramic body of the ornament and accessory losing the glaze layer or the electroplated layer. When the fragrance goes weak or is going to be replaced with another fragrance, the essential oil is absorbed into the inside of the ceramic body by dropping, spraying or dipping via the exposed portion of the ceramic body of the ornament and accessory losing the glaze layer or the electroplated layer, so as to repeatedly use the fragrant ceramic ornament and accessory. The rest ceramic surface without the concave pattern can be use as a portion of the ornament and accessory contacting with body directly. Because the glaze layer is a thin film of glass material which has good isolation effect of separating gas and liquid, and the products of electroplated layer also have good isolation effect, the essential oil is presented from contacting the body directly, so as to avoid the problems of discomfort or anaphylaxis, or staining or braking clothes.

The present invention has the following benefits. The ceramic body of the ornament and accessory has advantages of good absorbing effect and diffusing continuously for long. The surface of the ceramic ornament and accessory is glazed or electroplated fully, and various gay colors and effects can be formed by applying different glaze materials, or metallic effect can be formed by electroplating. By carving on the surface of the ceramic ornament and accessory with the sandblasting carving process, besides carving out beautiful patterns, an isolation effect of gas and liquid by the ceramic glaze layer or the electroplated layer is utilized ingeniously, so as to carve out the glaze layer or the electroplated layer on the surface of the ceramic body corresponding to the concave patterns, in such a manner that the essential oil is absorbed into the inside of the ceramic body by dropping, spraying or dipping via the exposed portion of the ceramic body of the ornament and accessory losing the glaze layer or the electroplated layer, and the fragrance can be changed by the same manner. Therefore, the rest srst ceramic surface without the concave pattern has isolation effect that prevents the essential oil from contacting with body directly due to glaze layer or the electroplated layer, so as to avoid the problems of discomfort or anaphylaxis, or staining or braking clothes of the essential oil. The fragrant ceramic ornament and accessory according to the present invention has more fashion and decoration in appearance, and more function and enjoyment in using. The present invention can be applied to ornament and accessory such as earrings, necklaces, hand chains, rings, bracelets, cuff links, and hairpins.

### BRIEF DESCRIPTION OF THE DRAWINGS

FIG. 1 is a perspective view of a fragrant ceramic hand chain with surface sandblasted and carved according to a preferred embodiment of the present invention.

FIG. 2 is a perspective view of a fragrant ceramic ring with surface sandblasted and carved according to a preferred embodiment of the present invention.

FIG. 3 is a perspective view of a fragrant ceramic pendant with surface sandblasted and carved according to a preferred embodiment of the present invention.

### DETAILED DESCRIPTION OF THE PREFERRED EMBODIMENT

Accompanied with the drawings, a technical proposal according to a preferred embodiment of the present invention is illustrated, but the present invention is not limited by the following, and the protective scope is determined in claims.

### Embodiment 1

Referring to FIG. 1, the present embodiment provides a fragrant ceramic hand chain with surface sandblasted and carved, comprising a fragrant ceramic body 1, a metal connector 2, a strand connector 3, and a metal ornament 4. The strand connector 3 passes through holes 1-1 and 1-2 provided on two sides of the fragrant ceramic body 1 to form a main body of the hand chain, the metal connector 2 is mounted on two ends of the strand connector 3, when the hand chain is worn around a wrist, the metal connector 2 is buckled to connect the hand chain end to end to form a ring mounted on the wrist entirely. The metal ornament 4 is for decoration of increasing aesthetic feeling. The fragrant ceramic body 1 of the hand chain has a concave pattern 1-3 carved by sandblasting carving and concave on a surface of the fragrant ceramic body 1. A glaze layer on the surface of the fragrant ceramic body 1 corresponding to the pattern is removed when sandblasting carving, essential oil can be absorbed into an inside of the fragrant ceramic body 1 via the concave pattern 1-3 losing glaze, and diffuse fragrance. A rest surface 1-4 of the fragrant ceramic body 1 of the hand chain is a portion remaining the glaze. When the hand chain is worn on the wrist, the rest surface 1-4 of the fragrant ceramic body 1 remaining the glaze contacts directly with skin of the wrist, but due to an isolation effect of the glaze, the essential oil absorbed inside the fragrant ceramic body 1 is separated from the skin of the wrist, so as to protect the skin from being hurt by the essential oil.

### Embodiment 2

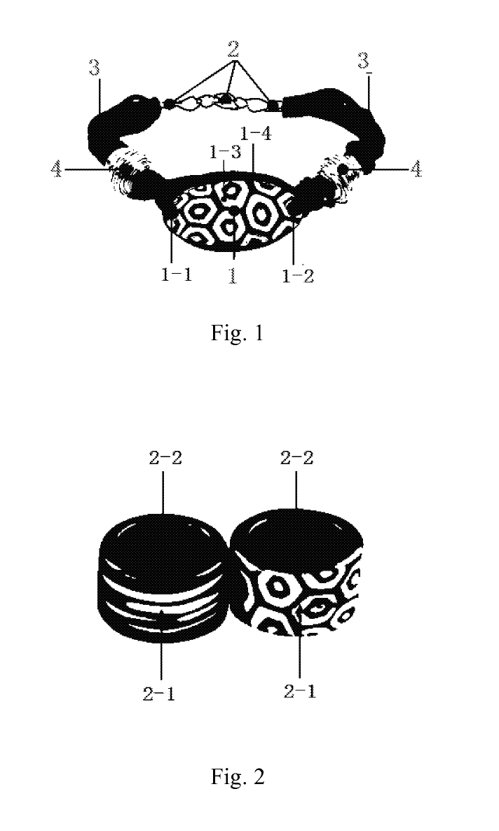

Referring to FIG. 2, the present embodiment provides a fragrant ceramic ring with surface sandblasted and carved, comprising a fragrant ceramic body formed by fragrant ceramic. The fragrant ceramic body of the ring has a concave pattern 2-1 carved by sandblasting carving and concave on a surface of the fragrant ceramic body. A glaze layer on the surface of the fragrant ceramic body corresponding to the pattern is removed when sandblasting carving, essential oil can be absorbed into an inside of the fragrant ceramic body via an exposed portion of the concave pattern 2-1 losing glaze, and diffuse fragrance. A rest surface 2-2 of the fragrant ceramic body of the ring is a portion remaining the glaze. When the ring is worn on a finger, the rest surface 2-2 of the fragrant ceramic body remaining the glaze contacts directly with skin of the finger, but due to an isolation effect of the glaze, the essential oil absorbed inside the fragrant ceramic body is separated from the skin of the finger, so as to protect the skin from being hurt by the essential oil. The glaze layer in the present embodiment can be replaced with an electroplated layer for products of metal texture.

### Embodiment 3

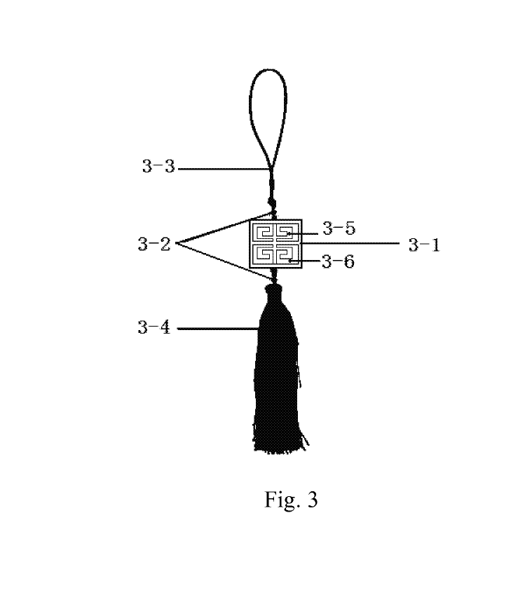

Referring to FIG. 3, the present embodiment provides a fragrant ceramic pendant with surface sandblasted and carved, comprising a fragrant ceramic body 3-1, a metal connector 3-2, a strand connector 3-3, and a tassel ornament 3-4. The strand connector 3-3 passes through a hole provided uprightly through the fragrant ceramic body 3-1 to form a main body of the pendant with the metal connector 3-2 and the tassel ornament 3-4. The fragrant ceramic body 3-1 of the pendant has a concave pattern 3-6 carved by sandblasting carving and concave on a surface of the fragrant ceramic body 3-1. A glaze layer on the surface of the fragrant ceramic body 3-1 corresponding to the pattern is removed when sandblasting carving, essential oil can be absorbed into an inside of the fragrant ceramic body 3-1 via the concave pattern 3-6 losing glaze, and diffuse fragrance. A rest surface 3-5 of the fragrant ceramic body 3-1 of the pendant is a portion remaining the glaze, for corresponding to positions of body or clothes which the essential oil possibly contacts. For example, when hanging in chest or on a leather bag, the rest surface 3-5 remaining the glaze can directly contact with the hanging clothes or leather without causing adverse effect, which is applicable widely and safe.

### Embodiment 4

The present embodiment provides a producing method of the fragrant ceramic ornament and accessory with surface sandblasted and carved, comprising:

first step of, producing a ceramic model with pug, wherein the pug comprises SiO₂ of 36.8%, Al₂O₃ of 60.20%, K₂O of 0.8%, and Na₂O of 2.2%, and the percentage is by weight;

second step of, drying the ceramic model;

third step of, glazing the dried ceramic model;

fourth step of, burning the glazed ceramic model in a furnace to sinter the glaze with the pug, wherein a temperature thereof is 1200±10° C., and a time thereof is 12˜15 hours; and

fifth step of, carving various concave pattern on the surface of the ceramic via sandblasting carving.

### Embodiment 5

The present embodiment provides a producing method of the fragrant ceramic ornament and accessory with surface sandblasted and carved, comprising:

first step of, producing a ceramic model with pug, wherein the pug comprises SiO₂ of 36.8%, Al₂O₃ of 60.20%, K₂O of 0.8%, and Na₂O of 2.2%, and the percentage is by weight;

second step of, drying the ceramic model;

third step of, glazing the dried ceramic model;

fourth step of, burning the glazed ceramic model in a furnace to sinter the glaze with the pug, wherein a temperature thereof is 1200±10° C., and a time thereof is 12˜15 hours;

fifth step of, electroplating the burned product to obtain metal texture and effect; and

sixth step of, carving various concave pattern on the surface of the ceramic via sandblasting carving.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1-10. (canceled)

11. A fragrant ceramic ornament and accessory with surface sandblasted and carved, comprises: a body of ornament and accessory, wherein said body of ornament and accessory is formed by a ceramic body capable of diffusing fragrance, wherein said ceramic body has a surface as an glaze layer or an electroplated layer which has concave pattern by sandblasting carving, wherein said concave pattern is an exposed portion of said ceramic body which loses said glaze layer or said electroplated layer and is concave on said surface of said ceramic body, wherein essential oil is absorbed into an inside of said ceramic body via said exposed portion.

12. The fragrant ceramic ornament and accessory with surface sandblasted and carved, as recited in claim 11, wherein said ceramic body absorbs said essential oil into said inside of said ceramic body via said concave pattern by dropping, spraying or dipping.

13. The fragrant ceramic ornament and accessory with surface sandblasted and carved, as recited in claim 11, wherein said ceramic body is a decorating part of different colors, shapes and sizes.

14. The fragrant ceramic ornament and accessory with surface sandblasted and carved, as recited in claim 12, wherein said ceramic body is a decorating part of different colors, shapes and sizes.

15. The fragrant ceramic ornament and accessory with surface sandblasted and carved, as recited in claim 11, wherein said ceramic body is hollow.

16. The fragrant ceramic ornament and accessory with surface sandblasted and carved, as recited in claim 12, wherein said ceramic body is hollow.

17. The fragrant ceramic ornament and accessory with surface sandblasted and carved, as recited in claim 11, wherein said ceramic body has a through hole thereon.

18. The fragrant ceramic ornament and accessory with surface sandblasted and carved, as recited in claim 12, wherein said ceramic body has a through hole thereon.

19. The fragrant ceramic ornament and accessory with surface sandblasted and carved, as recited in claim 11, wherein said glaze layer on said surface of said ceramic body is a thin film of glass material and capable of separating gas and liquid.

20. The fragrant ceramic ornament and accessory with surface sandblasted and carved, as recited in claim 12, wherein said glaze layer on said surface of said ceramic body is a thin film of glass material and capable of separating gas and liquid.

21. A producing method of the fragrant ceramic ornament and accessory with surface sandblasted and carved as recited in claim 11, comprising:
first step of, producing a ceramic model with pug;
second step of, drying the ceramic model;
third step of, glazing the dried ceramic model;
fourth step of, burning the glazed ceramic model in a furnace to sinter the glaze with the pug; and
fifth step of, carving various concave pattern on the surface of the ceramic via sandblasting carving.

22. The producing method of the fragrant ceramic ornament and accessory with surface sandblasted and carved, as recited in claim 21, wherein after the fourth step, the sintered product is electroplated before the fifth step.

23. The producing method of the fragrant ceramic ornament and accessory with surface sandblasted and carved, as recited in claim 21, wherein a temperature thereof is 1200±10° C., and a time thereof is 12˜15 hours.

24. The producing method of the fragrant ceramic ornament and accessory with surface sandblasted and carved, as recited in claim 22, wherein a temperature thereof is 1200±10° C., and a time thereof is 12˜15 hours.

25. A pug for producing the fragrant ceramic ornament and accessory with surface sandblasted and carved, comprising SiO₂ of 36.8%, Al₂O₃ of 60.20%, K₂O of 0.8%, and Na₂O of 2.2% by weight.
